(19) United States
(12) Patent Application Publication
(10) Pub. No.: US 2016/0359609 A1
(43) Pub. Date: Dec. 8, 2016

(54) COMMUNICATION DEVICE, COMMUNICATION SYSTEM, ESTIMATION METHOD, AND COMPUTER PROGRAM PRODUCT

(71) Applicant: Kabushiki Kaisha Toshiba, Minato-Ku (JP)

(72) Inventors: Masashi ITO, Yokohama (JP); Akira KAWARADA, Fuchu (JP)

(73) Assignee: Kabushiki Kaisha Toshiba, Minato-Ku (JP)

(21) Appl. No.: 14/959,513

(22) Filed: Dec. 4, 2015

(30) Foreign Application Priority Data
Jun. 5, 2015 (JP) 2015-115090

(51) Int. Cl. H04L 7/00

(52) U.S. Cl. CPC H04L 7/0008

(57) ABSTRACT

According to an embodiment, a communication device includes a communicating unit, an estimator, a determiner, an application, and a transmitter. The communicating unit is configured to communicate with another communication device over a network at each first cycle. The estimator is configured to calculate an outgoing communication delay and an incoming communication delay in communication between the communication device and the another communication device at each first cycle, and estimate a communication delay between the communication device and the another communication device based on the outgoing communication delay and the incoming communication delay. The determiner is configured to determine whether the communication delay satisfies a predetermined precision. The application is configured to generate application data at each second cycle. The transmitter is configured to transmit the application data to the network at each second cycle, at timing determined based on a determination result of the determiner within the second cycle.

### CROSS-REFERENCE TO RELATED APPLICATION

This application is based upon and claims the benefit of priority from Japanese Patent Application No. 2015-115090, filed on Jun. 5, 2015; the entire contents of which are incorporated herein by reference.

### FIELD

Embodiments described herein relate generally to a communication device, a communication system, an estimation method, and a computer program product.

### BACKGROUND

As a technology for avoiding confliction between the communication of data of a first type and the communication of data of types other than the first type in the network, conventionally known is prohibiting the communication of data of the types other than the first type, before communicating the data of the first type. A prior art example is disclosed in Japanese Laid-open Patent Publication No. 09-93275.

However, because the conventional technology prohibits the communication of data other than the data of the first type, when the data having its communication prohibited requires cyclic communication, the cyclic communication can no longer be ensured.

### BRIEF DESCRIPTION OF THE DRAWINGS

FIG. 1 is a schematic illustrating an exemplary configuration of a communication system according to a first embodiment;

FIG. 2 is a schematic illustrating an exemplary configuration of a slave device according to the first embodiment;

FIG. 3 is a schematic illustrating an exemplary configuration of a master device according to the first embodiment;

FIG. 4 is a flowchart illustrating an exemplary application data generating process according to the first embodiment;

FIG. 5 is a flowchart illustrating an exemplary application data transmitting process according to the first embodiment;

FIG. 6 is a sequence chart illustrating an exemplary synchronization process according to the first embodiment;

FIG. 7 is a flowchart illustrating an exemplary resetting process according to the first embodiment;

FIG. 8 is a schematic illustrating an exemplary configuration of a communication system according to a second embodiment;

FIG. 9 is a schematic illustrating an exemplary configuration of a slave device according to the second embodiment;

FIG. 10 is a schematic illustrating an exemplary configuration of a master device according to the second embodiment;

FIG. 11 is a schematic illustrating an exemplary configuration of a communication device according to the second embodiment;

FIG. 12 is a schematic illustrating an exemplary configuration of a management device according to the second embodiment;

FIG. 13 is a flowchart illustrating an exemplary process performed by the management device according to the second embodiment;

FIG. 14 is a flowchart illustrating an exemplary resetting process according to the second embodiment;

FIG. 15 is a schematic illustrating an exemplary configuration of a communication system according to a third embodiment;

FIG. 16 is a schematic illustrating an exemplary configuration of a communication device according to the third embodiment;

FIG. 17 is a schematic illustrating an exemplary configuration of a transfer device according to the third embodiment;

FIG. 18 is a flowchart illustrating an exemplary process performed by the communication device according to the third embodiment;

FIG. 19 is a flowchart illustrating an exemplary process performed by the transfer device according to the third embodiment; and

FIG. 20 is a schematic illustrating an exemplary hardware configuration of devices according to each of the embodiment.

### DETAILED DESCRIPTION

According to an embodiment, a communication device includes a communicating unit, an estimator, a determiner, an application, and a transmitter. The communicating unit is configured to communicate with another communication device over a network at each first cycle. The estimator is configured to calculate an outgoing communication delay and an incoming communication delay in communication between the communication device and the another communication device at each first cycle, and estimate a communication delay between the communication device and the another communication device based on the outgoing communication delay and the incoming communication delay. The determiner is configured to determine whether the communication delay satisfies a predetermined precision. The application is configured to generate application data at each second cycle. The transmitter is configured to transmit the application data to the network at each second cycle, at timing determined based on a determination result of the determiner within the second cycle.

Exemplary embodiments will now be explained in detail with reference to the attached drawings.

### First Embodiment

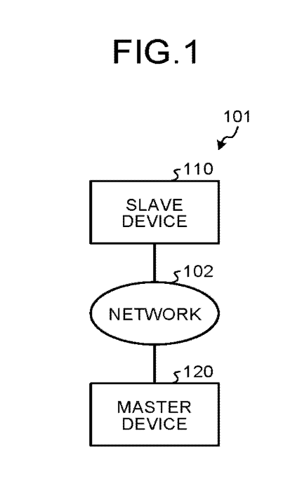

FIG. 1 is a schematic illustrating an exemplary configuration of a communication system 101 according to a first embodiment. As illustrated in FIG. 1, the communication system 101 includes a slave device 110 (an example of a communication device and a first communication device), and a master device 120 (an example of another communication device and a second communication device).

The slave device 110 and the master device 120 are connected to each other over a network 102. The network 102 can be implemented as one or more network devices such as switch devices that relay communication.

The master device 120 clocks reference time for time synchronization, and is a computer such as a server device that is a time source for synchronization. The slave device 110 acquires the reference time clocked by the master device 120 by communicating (exchanging) synchronization data for time synchronization with the master device 120 over the network 102, and synchronizes its local time using the acquired reference time. Examples of the slave device 110 include industrial machines, but the embodiment is not limited thereto.

The communication system 101 may also include another communication device that is connected to the network 102, in addition to the slave device 110 and the master device 120.

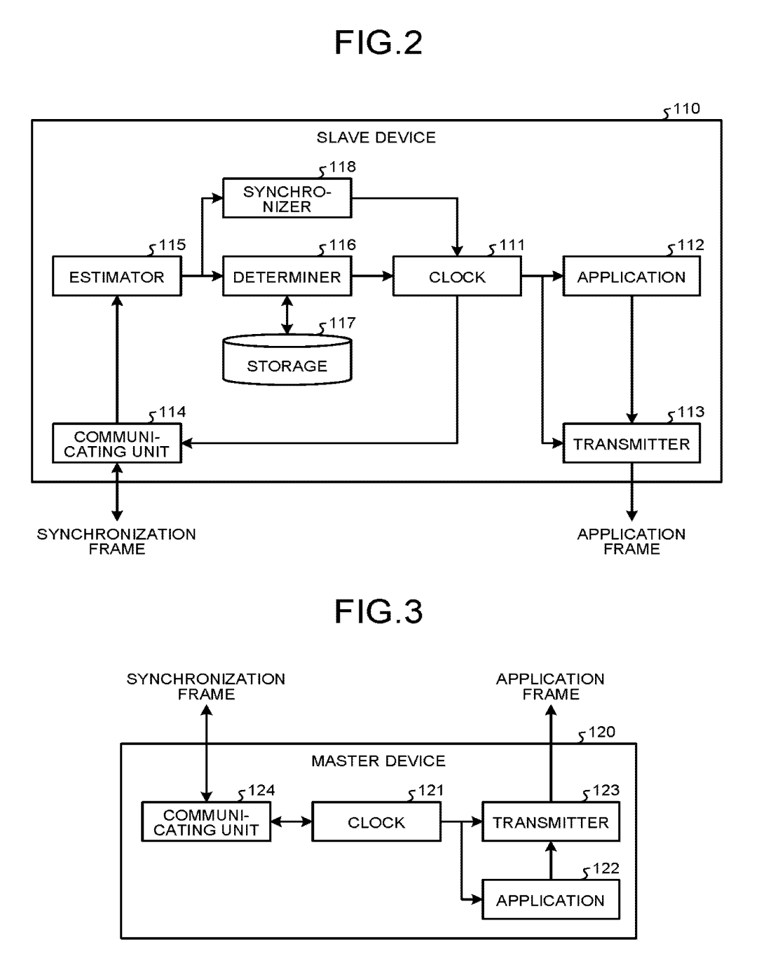

FIG. 2 is a schematic illustrating an exemplary configuration of the slave device 110 according to the first embodiment. As illustrated in FIG. 2, the slave device 110 includes a clock 111, an application 112, a transmitter 113, a communicating unit 114 (an example of a first communicating unit), an estimator 115, a determiner 116, a storage 117, and a synchronizer 118.

The clock 111, the application 112, the transmitter 113, the communicating unit 114, the estimator 115, the determiner 116, and the synchronizer 118 may be implemented by causing a processor such as a central processing unit (CPU) to execute a computer program, that is, implemented as software, may be implemented as hardware such as an integrated circuit (IC), or may be implemented as a combination of software and hardware. The storage 117 may be implemented as a storage device capable of magnetically, optically, or electrically storing, such as a hard disk drive (HDD), a solid state drive (SSD), a memory card, an optical disc, a random access memory (RAM), and a read-only memory (ROM).

The clock 111 clocks the local time that is the internal time of the slave device 110. The clock 111 also serves as a first cycle timer that clocks a first cycle, a second cycle timer that clocks the second cycle, and a set time timer that clocks set time that is set within the second cycle, using the local time clocked by the clock 111.

The first cycle is a cycle at which the slave device 110 synchronizes time with the master device 120. The second cycle is the cycle at which application data generated by the application 112 (hereinafter, referred to as “application data”) is transmitted. The first cycle and the second cycle may be different cycles, or the same cycle. The set time will be described later.

The communicating unit 114 communicates with the master device 120 over the network 102 every time the first cycle timer clocks the first cycle. Specifically, the communicating unit 114 exchanges synchronization frames of synchronization data for synchronizing time with the master device 120 over the network 102 at each first cycle.

For example, the communicating unit 114 transmits a first synchronization frame including a time stamp t1 indicating the local time clocked by the clock 111 (the local time at which the first cycle is clocked) to the master device 120 over the network 102 at each first cycle.

The communicating unit 114 then receives a second synchronization frame from the master device 120 over the network 102, and establishes the time stamp indicating the local time clocked by the clock 111 when the second synchronization frame is received, as a time stamp t4.

The second synchronization frame includes a time stamp t2 indicating the reference time at which the first synchronization frame is received by the master device 120, and the time stamp t3 indicating the reference time at which the second synchronization frame is transmitted by the master device 120 (an example of a first time stamp). The reference time is the time clocked by the master device 120.

The estimator 115 calculates an outgoing communication delay and incoming communication delay in the communication between the slave device 110 and the master device 120, at each first cycle, and estimates the communication delay between the slave device 110 and the master device 120 based on the outgoing communication delay and the incoming communication delay.

The communication delay herein is a delay time introduced to the reference time by the master device 120 in transmitting the reference time to the slave device 110 in order to allow the slave device 110 to synchronize its local time with the reference time clocked by the master device 120. The communication delay corresponds to, for example, the incoming communication delay from when the second synchronization frame is transmitted by the master device 120 to when the same second synchronization frame is received by the slave device 110.

The error between the reference time and the local time is however unknown, because the time at which the master device 120 transmits the second synchronization frame is clocked by the reference time that is clocked by the master device 120, and the time at which the slave device 110 receives the second synchronization frame is clocked by the local time of the slave device 110. Hence, it is impossible to make a direct measurement of the communication delay.

To address this issue, used in the first embodiment is an estimation method that uses a half of the round-trip communication delay that is the sum of the outgoing communication delay, which starts from when the first synchronization frame is transmitted by the slave device 110 and ends when the first synchronization frame is received by the master device 120, and the incoming communication delay, which starts from when the second synchronization frame is transmitted by the master device 120 and ends when the second synchronization frame is received by the slave device 110, as an estimation of the communication delay.

In this manner, because the error between the reference time and the local time is cancelled out by taking the sum of the outgoing communication delay and the incoming communication delay, the communication delay can be estimated without being affected by the error between the reference time and the local time.

In other words, in the first embodiment, the estimator 115 estimates the communication delay as a half of the round-trip communication delay that is the sum of the calculated outgoing communication delay and incoming communication delay. For example, the estimator 115 estimates the communication delay using Equation (1).

Communication delay={(t4−t3)+(t2−t1)}/2 (1)

With this communication delay estimation, however, a communication delay cannot be estimated correctly unless the outgoing communication delay matches the incoming communication delay.

In the network 102 transferring the synchronization frame (more specifically, one or more network devices), however, if the synchronization frame conflicts with a communication frame other than the synchronization frame, e.g., an application frame, the time for which the synchronization frame is queued fluctuates, and the outgoing communication delay of the synchronization frame might not match the incoming communication delay.

In other words, when both of the outgoing communication delay and the incoming communication delay are short, the queuing time fluctuates less, so that the difference between the outgoing communication delay and the incoming communication delay is also reduced. Hence, in order to estimate the communication delay correctly, it is desirable to use an outgoing communication delay and an incoming communication delay that are shorter in time.

The estimator 115 may therefore extract a shortest one of a plurality of outgoing communication latencies and a shortest one of a plurality of incoming communication latencies, and estimate a half of the round-trip communication delay that is the sum of the extracted shortest outgoing communication delay and the extracted shortest incoming communication delay, as the communication delay.

In such a case, the estimator 115 acquires a set of the time stamps t1 to t4 from the communicating unit 114. The estimator 115 also acquires a plurality of sets of time stamps t1 to t4 having been acquired in the past from the communicating unit 114. The sets of time stamps t1 to t4 having been acquired in the past from the communicating unit 114 may be kept stored in the storage 117, for example.

Denoting the number of acquired sets of time stamps t1 to t4 by N (where N is an integer equal to or greater than 2), the estimator 115 estimates the communication delay using Equation (2).

Communication delay={min(t4ᵢ−t3ᵢ)+min(t2ⱼ−t1ⱼ)}/2 (2)

In this equation, i and j are variables taking natural numbers between 1 to N. min(t4ᵢ−t3ᵢ) is a function returning the shortest incoming communication delay, and min(t2ⱼ−t1ⱼ) is a function returning the shortest outgoing communication delay.

The synchronizer 118 then synchronizes the time based on the communication delay estimated by the estimator 115, and on the time stamp t3.

Specifically, the synchronizer 118 calculates the offset (time difference) between the reference time clocked by the master device 120 and the local time clocked by the clock 111 using the communication delay estimated by the estimator 115, the time stamp t3, and the time stamp t4, and causes the clock 111 to correct the local time clocked by the clock 111 using the calculated offset.

For example, the synchronizer 118 calculates the offset using Equation (3), and causes the clock 111 to correct the clocked local time by causing the clock 111 to set the calculated offset. In this manner, the local time clocked by the clock 111 is shifted by the offset, and synchronized with the reference time clocked by the master device 120.

Offset=t4−{t3+Communication delay} (3)

When the estimator 115 estimates the communication delay using Equation (2), the synchronizer 118 calculates the offset using Equation (4), and causes the clock 111 to correct the clocked local time by causing the clock 111 to set the calculated offset.

offset=t4_{argmin(t4i-t3i)}−{t3_{argmin(t4i-t3i)}+Communication delay} (4)

argmin(t4ᵢ−t3ᵢ) is a function returning a variable “i” resulting in smallest t4ᵢ−t3ᵢ. In other words, with Equation (4), the synchronizer 118 calculates the offset between the reference time clocked by the master device 120 and the local time clocked by the clock 111 using the communication delay estimated by the estimator 115 and the time stamp t3 and the time stamp t4 resulting in the shortest incoming communication delay.

The determiner 116 determines whether the communication delay estimated by the estimator 115 satisfies a predetermined precision.

For example, the determiner 116 acquires the communication delay from the estimator 115. The storage 117 stores therein a plurality of communication delays acquired by the determiner 116 in the past from the estimator 115. The determiner 116 acquires the shortest communication delay from the storage 117.

The determiner 116 then adds predetermined time to the shortest communication delay acquired from the storage 117, and determines whether the communication delay acquired from the estimator 115 is shorter than the time resulting from adding the predetermined time to the shortest communication delay. The reason why the predetermined time is added to the shortest communication delay is to give some allowance to the determination.

As a result of the determination, if the communication delay acquired from the estimator 115 is shorter, the determiner 116 determines that the predetermined precision is satisfied. If the communication delay acquired from the estimator 115 is not shorter, the determiner 116 determines that the predetermined precision is not satisfied.

Once the communication delay is determined, the determiner 116 stores the communication delay acquired from the estimator 115 in the storage 117.

The set time clocked by the clock 111 will now be explained. If the determiner 116 determines that the communication delay does not satisfy the predetermined precision, the clock 111 resets the set time. The set time is time shorter than the second cycle, and may be determined by the clock 111 using a random number or the like, or may be determined by shifting a predetermined phase within the second cycle. If the determiner 116 determines that the communication delay satisfies the predetermined precision, the clock 111 keeps using the time previously set, without resetting the set time.

Therefore, the set time is not changed while the determiner 116 determines that communication delay satisfies the predetermined precision, but is changed when the determiner 116 determines that the communication delay does not satisfy the predetermined precision.

The set time timer clocks the set time set in the manner described above. Specifically, once the second cycle timer starts clocking the second cycle, the set time timer starts clocking the set time, and keeps clocking the set time in the second cycle.

Every time the second cycle timer clocks the second cycle, the application 112 generates application data.

Explained in the first embodiment is an example in which the application 112 is an application that measures an amount of electric power, but the embodiment is not limited thereto. In this example, the application 112 measures an amount of electric power at each second cycle, and adds (stamps) a time stamp tα indicating time in the local time clocked by the clock 111 to the measured amount of electric power (the local time at which the second cycle is clocked, and the local time at which the application data is generated) (an example of a second time stamp), and uses the data as the application data.

The transmitter 113 transmits the application data generated by the application 112 to the network 102 at each second cycle, at the timing dependent on the determination result of the determiner 116 within the second cycle. Specifically, the transmitter 113 transmits an application frame of the application data generated by the application 112 to the network 102 at the timing at which the set time timer clocks the set time.

If the determiner 116 determines that the communication delay does not satisfy the predetermined precision, the set time has been reset. The transmitter 113 therefore transmits the application frame to the network 102 at timing different from that at which a frame was transmitted previous time within the second cycle. By contrast, if the determiner 116 determines that the communication delay satisfies the predetermined precision, the set time has not been reset. The transmitter 113 therefore transmits the application frame to the network 102 at the same timing as that at which a frame was transmitted previous time within the second cycle.

FIG. 3 is a schematic illustrating an exemplary configuration of the master device 120 according to the first embodiment. As illustrated in FIG. 3, the master device 120 includes a clock 121, an application 122, a transmitter 123, and a communicating unit 124 (an example of a second communicating unit).

The clock 121, the application 122, the transmitter 123, and the communicating unit 124 may be implemented by causing a processor such as a CPU to execute a computer program, that is, implemented as software, may be implemented as hardware such as an IC, or may be implemented as a combination of software and hardware.

The clock 121 clocks the reference time that is the internal time of the master device 120. The clock 121 also serves as a third cycle timer that clocks a third cycle, using the reference time clocked by the clock 121.

The third cycle is a cycle at which the application data generated by the application 122 is transmitted. In the first embodiment, the third cycle is explained to be the same as the second cycle, but may be a different cycle.

The application 122 generates application data every time the third cycle is clocked by the third cycle timer.

Explained in the first embodiment is an example in which the application 122 is an application for measuring an amount of electric power, but the embodiment is not limited thereto. In this example, the application 122 measures the amount of electric power at each third cycle, and adds (stamps) a time stamp tβ indicating the reference time clocked by the clock 121 (the reference time at which the third cycle is clocked, and the reference time at which the application data is generated) to the measured electric power, and uses the data as the application data.

The transmitter 123 then transmits the application data generated by the application 122 to the network 102.

The communicating unit 124 communicates with the slave device 110 over the network 102 at each first cycle. Specifically, the communicating unit 124 communicates the synchronization frames of the synchronization data for time synchronization with the slave device 110 over the network 102, at each first cycle.

For example, the communicating unit 124 receives a first synchronization frame including the time stamp t1 from the slave device 110 over the network 102 at each first cycle, and establishes the time stamp indicating the reference time, clocked by the clock 121, at which the first synchronization frame is received, as the time stamp t2.

The communicating unit 124 establishes the time stamp indicating the reference time, clocked by the clock 121, at which the second synchronization frame is transmitted, as the time stamp t3, and transmits the second synchronization frame including the time stamp t2 and the time stamp t3 to the slave device 110 over the network 102.

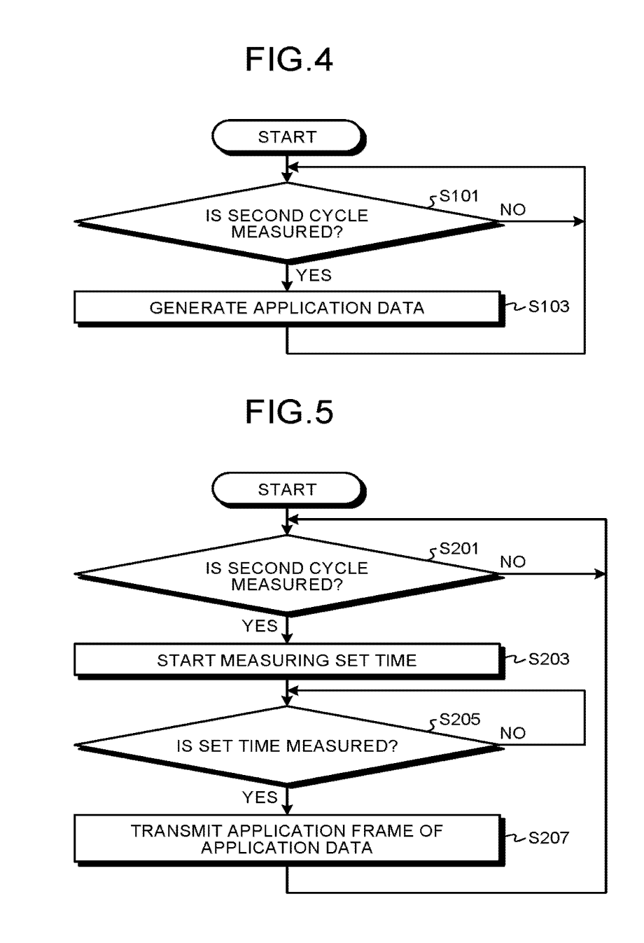

FIG. 4 is a flowchart illustrating exemplary steps of an application data generating process performed in the slave device 110 according to the first embodiment.

The application 112 waits until the second cycle timer clocks (measures) the second cycle (No at Step S101).

When the second cycle timer clocks the second cycle (Yes at Step S101), the application 112 measures the amount of electric power, and generates application data by adding (stamping) a time stamp tα indicating the local time clocked by the clock 111 to the measured amount of electric power (Step S103). The process then returns to Step S101.

FIG. 5 is a flowchart illustrating exemplary steps of the application data transmitting process performed in the slave device 110 according to the first embodiment.

The set time timer waits until the second cycle is clocked (measured) by the second cycle timer (No at Step S201), and when the second cycle timer clocks the second cycle (Yes at Step S201), the set time timer starts clocking the set time (Step S203).

The transmitter 113 then waits until the set time timer clocks the set time (No at Step S205). When the set time timer clocks the set time (Yes at Step S205), the transmitter 113 transmits an application frame of the application data generated by the application 112 to the network 102 (Step S207). The process then returns to Step S201.

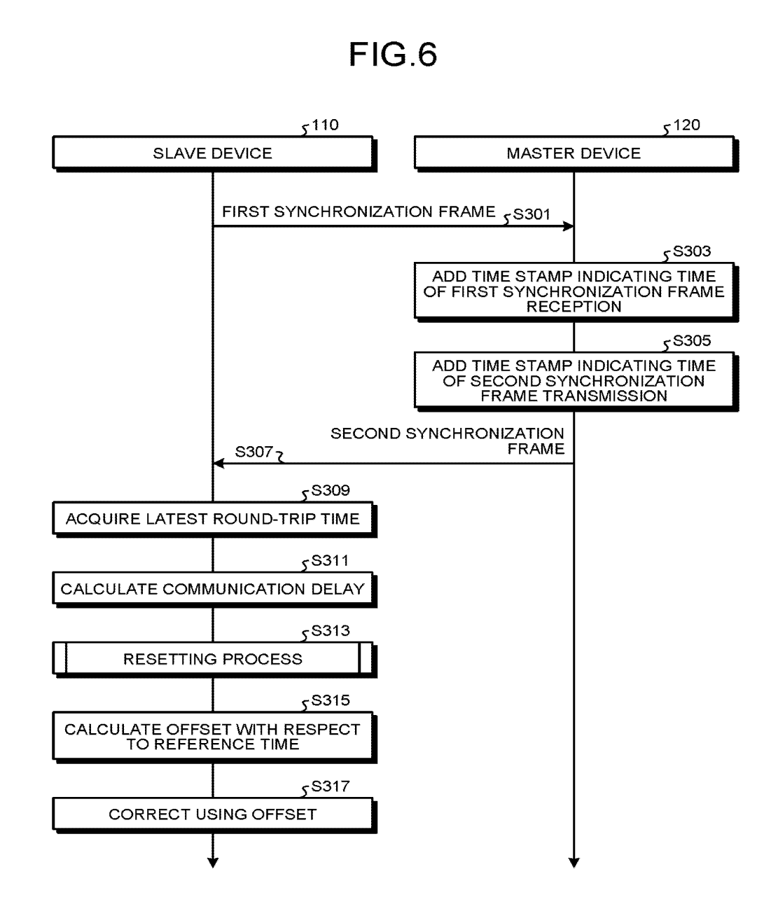

FIG. 6 is a sequence chart illustrating exemplary steps of a synchronization process performed in the communication system 101 according to a first embodiment.

To begin with, when the first cycle timer clocks the first cycle, the communicating unit 114 in the slave device 110 transmits the first synchronization frame including the time stamp t1 indicating the local time clocked by the clock 111 to the master device 120 over the network 102 (Step S301).

The communicating unit 124 in the master device 120 then receives the first synchronization frame from the slave device 110 over the network 102, and stamps the time stamp t2 indicating the reference time, clocked by the clock 121, at which the first synchronization frame is received to the second synchronization frame (Step S303).

The communicating unit 124 then stamps the time stamp t3 indicating the reference time, clocked by the clock 121, at which the second synchronization frame is transmitted to the second synchronization frame (Step S305), and transmits the second synchronization frame including the time stamp t2 and the time stamp t3 to the slave device 110 over the network 102 (Step S307).

The communicating unit 114 then receives the second synchronization frame from the master device 120 over the network 102, and the estimator 115 in the slave device 110 acquires the latest sets of time stamps t1 to t4, as the latest round-trip communication delay, from the communicating unit 114 (Step S309).

The estimator 115 then calculates (estimates) the communication delay using Equation (1) (Step S311).

The determiner 116 and the clock 111 then perform a set time resetting process (Step S313). The resetting process will be described later in detail.

The synchronizer 118 then calculate the offset between the reference time clocked by the master device 120 and the local time clocked by the clock 111 using Equation (3) (Step S315), and causes the clock 111 to correct the clocked local time using the calculated offset (Step S317).

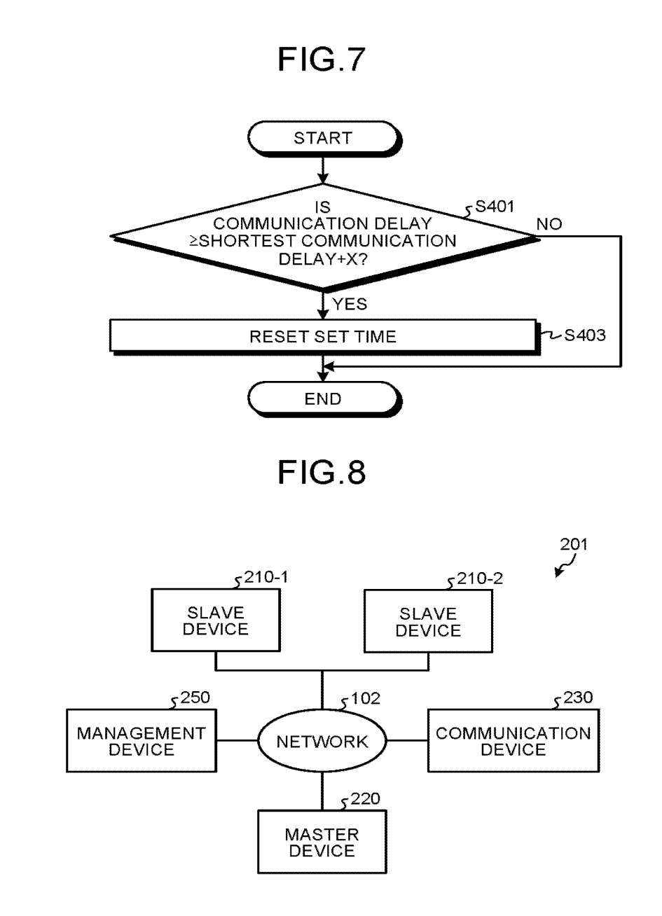

FIG. 7 is a flowchart illustrating an exemplary steps of the resetting process performed in the slave device 110 according to the first embodiment.

To begin with, the determiner 116 acquires the communication delay from the estimator 115, and acquires the shortest communication delay from the storage 117. The determiner 116 then adds predetermined time X to the shortest communication delay, and determines whether the communication delay acquired from the estimator 115 is shorter than the addition of the predetermined time X to the shortest communication delay (Step S401).

As a result of the determination, if the communication delay acquired from the estimator 115 is shorter (No at Step S401), the determiner 116 determines that the predetermined precision is satisfied, and the clock 111 does not reset the set time.

As a result of the determination, if the communication delay acquired from the estimator 115 is not shorter (Yes at Step S401), the determiner 116 determines that the predetermined precision is not satisfied, and causes the set time to be reset (Step S403).

As described above, according to the first embodiment, if the communication delay does not satisfy the predetermined precision, the timing at which the application frame is transmitted is changed in the second cycle, and if the communication delay satisfies the predetermined precision, the timing at which the application frame is transmitted is not changed in the second cycle.

In other words, according to the first embodiment, if the communication delay does not satisfy the predetermined precision, so that an application frame is more likely to conflict with a synchronization frame in the network 102, and the queuing time of the synchronization frame is more likely to fluctuate, the timing for transmitting the application frame is changed. If the communication delay satisfies the predetermined precision, so that an application frame is less likely to conflict with a synchronization frame in the network 102, and the queuing time of the synchronization frame is less likely to fluctuate, the timing for transmitting the application frame is fixed.

Therefore, according to the first embodiment, the communication delay becomes more likely to satisfy the predetermined precision, as the longer time elapses. Because the time is synchronized using such a communication delay with a high estimation precision, the time synchronization precision can also be improved.

In other words, according to the first embodiment, because the time can be synchronized while avoiding confliction in the network 102 at the same time, time synchronization precision can be improved, and the cyclic communication of application data can be ensured.

### Second Embodiment

Explained in a second embodiment is an example in which a management device centrally determines whether the communication delay satisfies the predetermined precision. In the explanation hereunder, differences with the first embodiment will be mainly explained, and the elements having functions equivalent to those in the first embodiment will be assigned with the same names and the same reference numerals as those in the first embodiment, and explanations thereof are omitted herein.

FIG. 8 is a schematic illustrating an exemplary configuration of a communication system 201 according to the second embodiment. The communication system 201 is different from the communication system 101 according to the first embodiment in having a plurality of slave devices 210-1 and 210-2, a master device 220, a communication device 230, and a management device 250.

In the explanation hereunder, the slave devices 210-1 and 210-2 are sometimes simply referred to as slave devices 210 when they do not need to be distinguished from each other. Furthermore, in the example illustrated in FIG. 8, the number of slave devices 210 is two, and the number of the communication device 230 is one, but the numbers of the devices are not limited thereto.

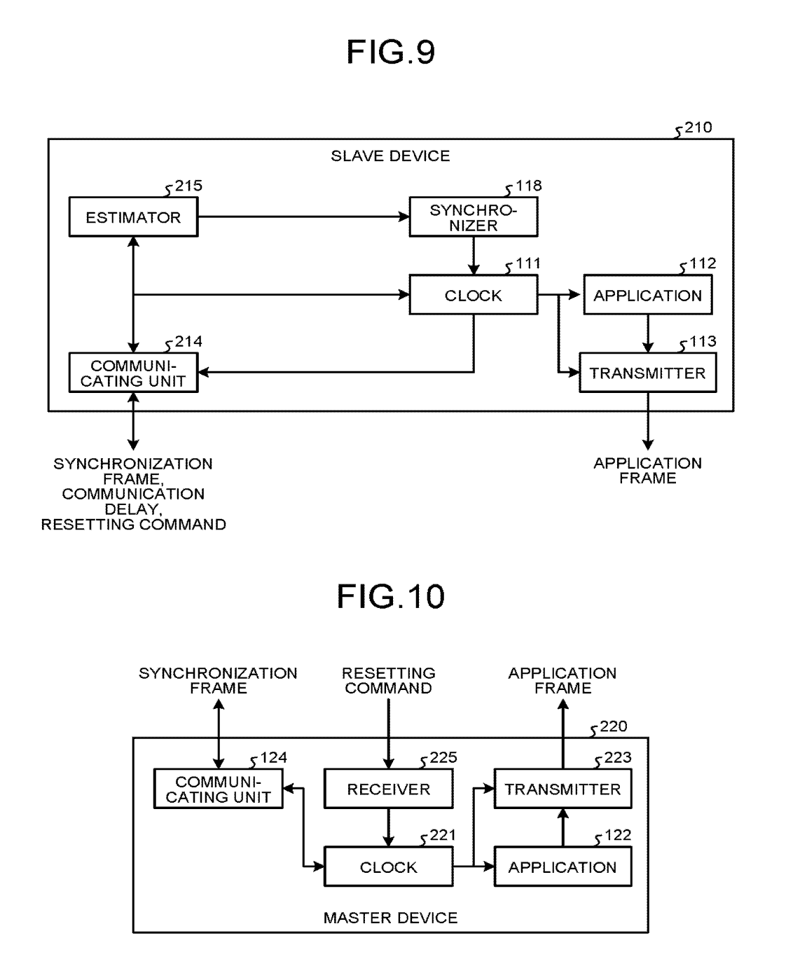

FIG. 9 is a schematic illustrating an exemplary configuration of the slave device 210 according to the second embodiment. As illustrated in FIG. 9, the slave device 210 includes a communicating unit 214 and an estimator 215 that are different from the corresponding units in the first embodiment. In the second embodiment, the communicating unit 214 is an example of the first communicating unit and the second communicating unit, and the application 112 is an example of a first application. The application data generated by the application 112 is an example of first application data, and the transmitter 113 is an example of a first transmitter.

Once the estimator 215 estimates the communication delay, the communicating unit 214 acquires communication delay from the estimator 215, and transmits the communication delay to the management device 250. The communicating unit 214 also receives a resetting command from the management device 250.

When a resetting command is received by the communicating unit 214, the clock 111 resets the set time. If no resetting command is received by the communicating unit 214, the clock 111 keeps using the time previously set, without resetting the set time.

When the communicating unit 214 has received a resetting command, the set time has been reset. Therefore, the transmitter 113 transmits an application frame to the network 102 at timing different from that at which a frame was transmitted previous time within the second cycle. When the communicating unit 214 has not received a resetting command, because the set time has not been reset, the transmitter 113 transmits the application frame to the network 102 at the same timing as that at which a frame was transmitted previous time in the second cycle.

FIG. 10 is a schematic illustrating an exemplary configuration of the master device 220 according to the second embodiment. As illustrated in FIG. 10, the master device 220 includes a clock 221, a transmitter 223, and a receiver 225 that are different from the corresponding units in the first embodiment. In the second embodiment, the application 122 is an example of a second application, and the application data generated by the application 122 is an example of second application data. The transmitter 223 is an example of a third transmitter, and the communicating unit 124 is an example of a third communicating unit. The receiver 225 is an example of the second receiver.

The receiver 225 receives a resetting command from the management device 250.

The clock 221 serves as a set time timer that clocks the set time within the third cycle, using the reference time clocked by the clock 221. If a resetting command is received by the receiver 225, the clock 221 resets the set time. If no resetting command is received by the receiver 225, the clock 221 keeps using the time previously set, without resetting the set time. The set time is a time shorter than the third cycle, for example, and may be determined by the clock 221 using a random number or the like, or may be determined by shifting a predetermined phase within the third cycle.

The set time timer clocks the set time set in the manner described above. Specifically, the set time timer starts clocking the set time when the third cycle timer clocks the third cycle, and clocks the set time within the third cycle.

The transmitter 223 transmits the application data generated by the application 122 to the network 102 at each third cycle and at timing determined depending on whether a resetting command has been received within the third cycle. Specifically, the transmitter 223 transmits an application frame of the application data generated by the application 122 to the network 102 when the set time timer clocks the set time.

If the resetting command has been received by the receiver 225, the set time has been reset. Therefore, the transmitter 223 transmits the application frame to the network 102 at timing different from that at which a frame was transmitted previous time within the third cycle. If no resetting command is received by receiver 225, because the set time has not been reset, the transmitter 223 transmits the application frame to the network 102 at the same timing as that at which a frame was transmitted previous time within the third cycle.

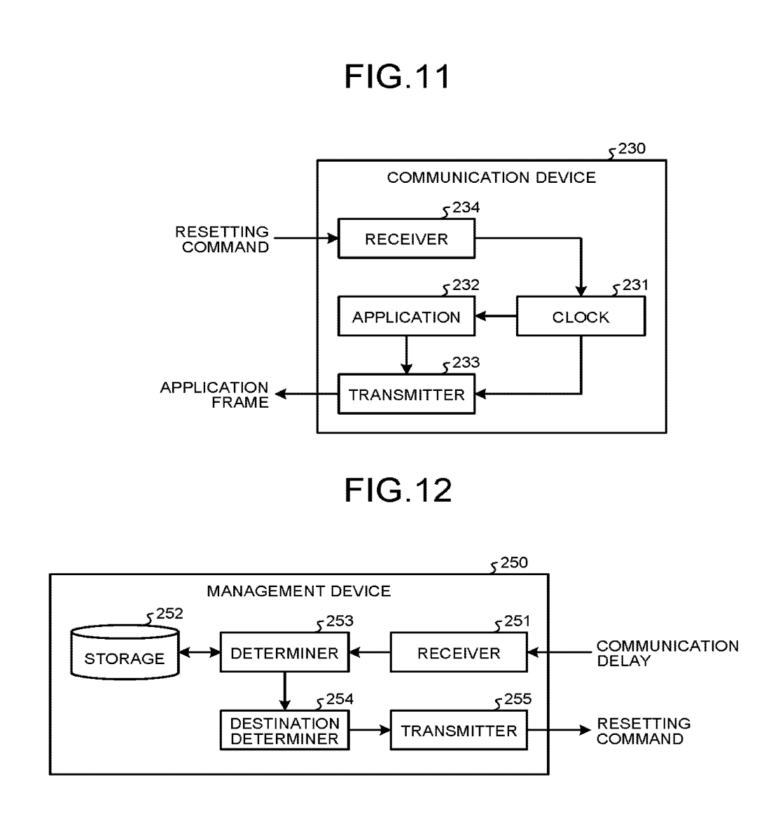

FIG. 11 is a schematic illustrating an exemplary configuration of the communication device 230 according to the second embodiment. As illustrated in FIG. 11, the communication device 230 includes a clock 231, an application 232 (an example of a third application), a transmitter 233 (an example of a fourth transmitter), and a receiver 234 (an example of a third receiver).

The clock 231, the application 232, the transmitter 233, and the receiver 234 may be implemented by causing a processor such as a CPU to execute a computer program, that is, implemented as software, may be implemented as hardware such as an IC, or may be implemented as a combination of software and hardware.

The receiver 234 receives a resetting command from the management device 250.

The clock 231 clocks the local time that is the internal time of the communication device 230. The clock 231 serves as a fourth cycle timer that clocks the fourth cycle using the local time clocked by the clock 231, and as a set time timer that clocks the set time within the fourth cycle.

The fourth cycle is a cycle at which the application data (an example of third application data) generated by the application 232 is transmitted. In the second embodiment, the fourth cycle is explained to be the same as the second cycle and the third cycle, but may be a cycle different from these cycles.

If a resetting command is received by the receiver 234, the clock 231 resets the set time. If no resetting command is received by the receiver 234, the clock 231 keeps using the time previously set, without resetting the set time. The set time is a time shorter than the fourth cycle, for example, and may be determined by the clock 231 using a random number or the like, or may be determined by shifting a predetermined phase within the fourth cycle.

The set time timer clocks the set time set in the manner described above. Specifically, when the fourth cycle timer clocks the fourth cycle, the set time timer starts clocking the set time, and clocks the set time within the fourth cycle.

The application 232 generates application data every time the fourth cycle timer clocks the fourth cycle. Explained in the second embodiment is an example in which the application 232 is an application for measuring an amount of electric power, but the embodiment is not limited thereto. In this example, the application 232 measures the amount of electric power at each fourth cycle, and adds (stamps) a time stamp ty indicating local time clocked by the clock 231 (the reference time at which the fourth cycle is clocked, and the reference time at which the application data is generated) to the measured electric power, and uses the data as application data.

The transmitter 233 transmits application data generated by the application 232 to the network 102, at each fourth cycle, at timing determined depending on whether a resetting command has been received within the fourth cycle. Specifically, the transmitter 233 transmits an application frame of the application data generated by the application 232 to the network 102 when the set time timer clocks the set time.

If the resetting command has been received by the receiver 234, the set time has been reset. Therefore, the transmitter 233 transmits the application frame to the network 102 at timing different from that at which a frame was transmitted previous time within the fourth cycle. If no resetting command is received by receiver 234, because the set time has not been reset, the transmitter 233 transmits the application frame to the network 102 at the same timing as that at which a frame was transmitted previous time within the fourth cycle.

FIG. 12 is a schematic illustrating an exemplary configuration of the management device 250 according to the second embodiment. As illustrated in FIG. 12, the management device 250 includes a receiver 251 (an example of a first receiver), a storage 252, a determiner 253, a destination determiner 254, and a transmitter 255 (an example of a second transmitter).

The receiver 251, the determiner 253, the destination determiner 254, and the transmitter 255 may be implemented by causing a processor such as a CPU to execute a computer program, that is, implemented as software, may be implemented as hardware such as an IC, or may be implemented as a combination of software and hardware. The storage 252 may be implemented as a storage device capable of magnetically, optically, or electrically storing such as an HDD, an SSD, a memory card, an optical disc, a RAM, and a ROM.

The receiver 251 receives the communication delay from each of the slave devices 210.

The determiner 253 determines whether a plurality of communication delays received by the receiver 251 satisfy the predetermined precision. The communication delay corresponding to each of the slave devices 210 acquired in the past from the receiver 251 by the determiner 253 is stored in the storage 252.

Therefore, the determiner 253 can determine whether each piece of the communication delay received by the receiver 251 satisfies the predetermined precision, using the same approach as that used by the determiner 116 in the slave device 110 according to the first embodiment, or may determine whether the predetermined precision is satisfied by comparing the respective sums of communication delay, using the same approach as that used by the determiner 116 in the slave device 110 according to the first embodiment. In the former example, the determiner 253 determines that the predetermined precision is satisfied when every piece of the communication delay satisfies the predetermined precision.

Once the communication delay is determined, the determiner 253 stores the communication delay acquired from the receiver 251 in the storage 252.

If the communication delays do not satisfy the predetermined precision, the destination determiner 254 determines one or more of the slave devices 210 as a destination to which the resetting command is to be transmitted. For example, the destination determiner 254 determines a slave device 210 having a communication delay not satisfying the predetermined precision as a destination to which the resetting command is to be transmitted.

The destination determiner 254 may determine one or more of the slave devices 210, the master device 220, and the communication device 230 as a destination to which the resetting command is to be transmitted. In this example, the destination determiner 254 may determine the one or more devices to which the resetting command is to be transmitted randomly from the slave devices 210, the master device 220, and the communication device 230, or may determine the one or more devices to which the resetting command is to be transmitted in a predetermined order.

The transmitter 255 transmits a resetting command to the one or more devices determined by the destination determiner 254.

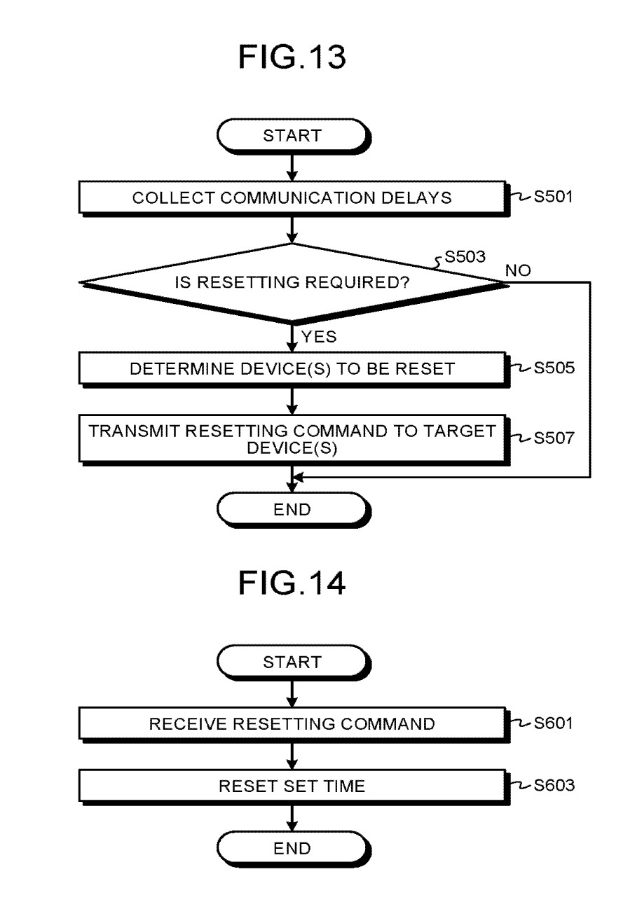

FIG. 13 is a flowchart illustrating exemplary steps of a process performed in the management device 250 according to the second embodiment.

To begin with, the receiver 251 collects (receives) the communication delay from each of the slave devices 210 (Step S501).

The determiner 253 then determines whether the set time needs to be reset by determining whether the communication delays received by the receiver 251 satisfy the predetermined precision (Step S503).

If the communication delays do not satisfy the predetermined precision and the set time needs to be reset (Yes at Step S503), the destination determiner 254 determines one or more of the slave devices 210, the master device 220, and the communication device 230 as a destination to which the resetting command is to be transmitted (Step S505).

The transmitter 255 then transmits a resetting command to one or more destination devices determined by the destination determiner 254 (Step S507).

If the set time does not need to be reset (No at Step S503), the process is ended.

FIG. 14 is a flowchart illustrating an exemplary steps of a resetting process performed in the slave device 210 according to the second embodiment.

When the communicating unit 214 receives a resetting command from the management device 250 (Step S601), the clock 111 resets the set time (Step S603).

In the master device 220, when the receiver 225 receives the resetting command from the management device 250, the clock 221 resets the set time. In the communication device 230, when the receiver 234 receives the resetting command from the management device 250, the clock 231 resets the set time.

As described above, according to the second embodiment, if the communication delay does not satisfy the predetermined precision, the timing at which the application frame is transmitted is changed in the master device and the communication device, within their respective cycles. Therefore, it requires shorter time for the communication delay to satisfy the predetermined precision.

### Third Embodiment

Explained in a third embodiment is an example in which the communication device transmits application data at random timing using a transfer device. In the explanation hereunder, differences with the second embodiment will be mainly explained, and the elements having functions equivalent to those in the second embodiment will be assigned with the same names and the same reference numerals as those in the first embodiment, and explanations thereof are omitted herein.

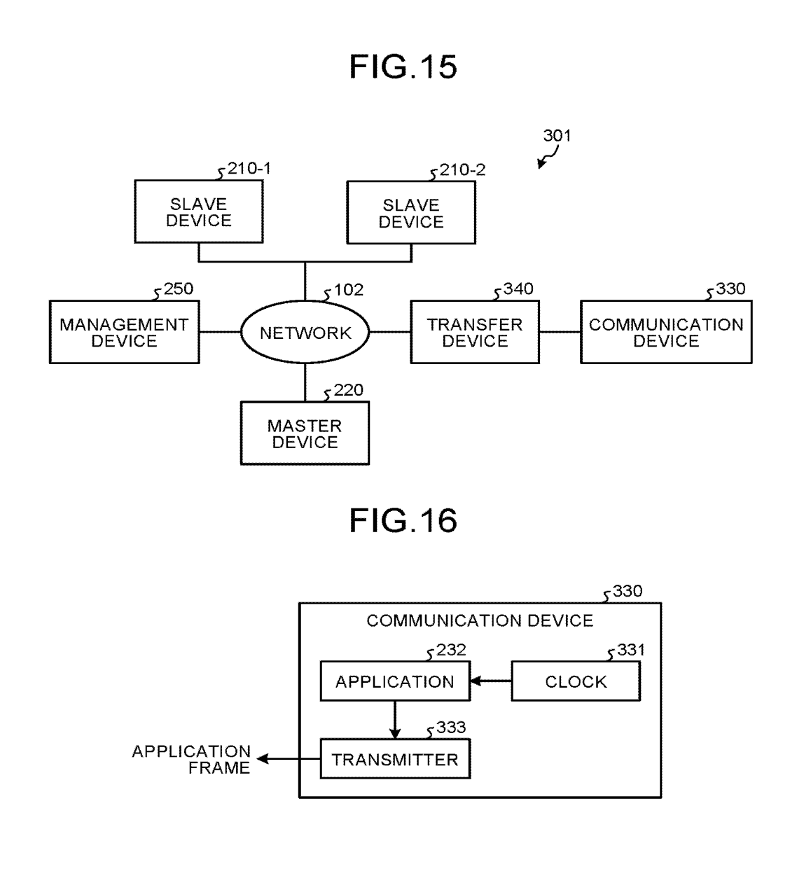

FIG. 15 is a schematic illustrating an exemplary configuration of a communication system 301 according to the third embodiment. This configuration is different from that according to the second embodiment in including a transfer device 340 that is connected to the network 102, and a communication device 330 connected to the transfer device 340. Examples of the transfer device 340 includes devices that are directly connected to the communication device 330, such as a network card in the communication device 330 or a universal serial bus (USB) converter, but may also be a device connected to the communication device 330 over the network 102.

FIG. 16 is a schematic illustrating an exemplary configuration of the communication device 330 according to the third embodiment. As illustrated in FIG. 16, the clock 331 and the transmitter 333 in the communication device 330 are different from the corresponding units in the second embodiment.

In the third embodiment, the clock 331 does not function as a set time timer.

The transmitter 333 transmits application data to the transfer device 340 when the application 232 generates the application data.

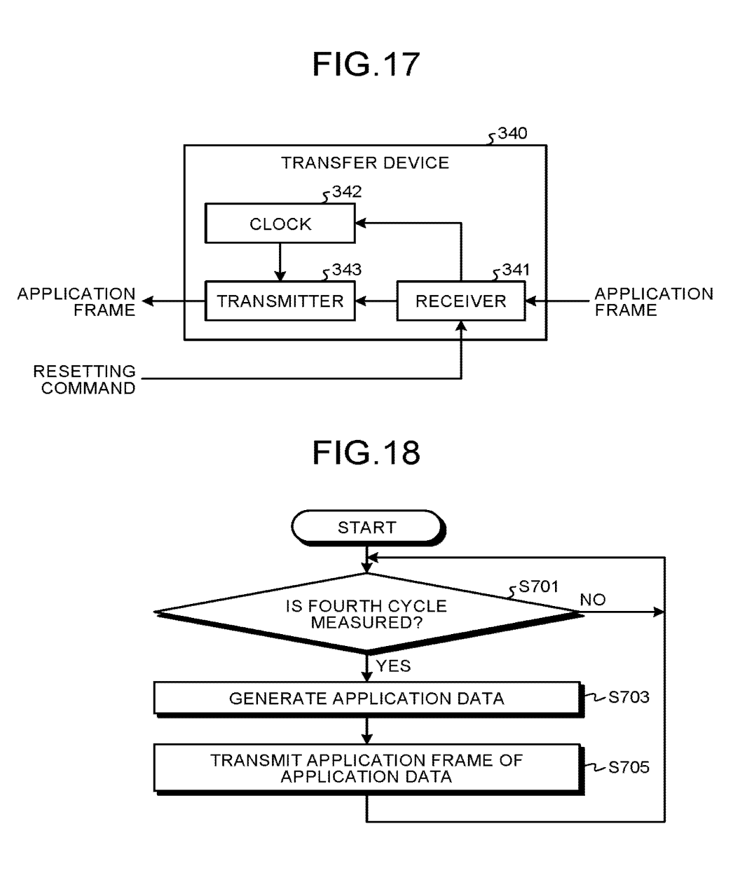

FIG. 17 is a schematic illustrating an exemplary configuration of the transfer device 340 according to the third embodiment. As illustrated in FIG. 17, the transfer device 340 includes a receiver 341 (an example of a fourth receiver), a clock 342, and a transmitter 343 (an example of a fifth transmitter).

The receiver 341, the clock 342, and the transmitter 343 may be implemented by causing a processor such as a CPU to execute a computer program, that is, implemented as software, may be implemented as hardware such as an IC, or may be implemented as a combination of software and hardware.

The receiver 341 receives application data from the communication device 330. The receiver 341 also receives a resetting command from the management device 250.

The clock 342 clocks the local time that is the internal time of the transfer device 340 The clock 342 serves as a fourth cycle timer, that clocks the fourth cycle, and set time timer that clocks the set time within the fourth cycle, using the local time clocked by the clock 342.

It is assumed herein that the fourth cycle timer is synchronized with the fourth cycle timer of the clock 331 in the communication device 330. In other words, the fourth cycle timer in the clock 331 and the fourth cycle timer in the clock 342 clock the fourth cycle at the same timing.

If a resetting command is received by the receiver 341, the clock 342 resets the set time. If no resetting command is received by the receiver 341, the clock 342 keeps using the time previously set, without resetting the set time. The set time is a time shorter than the fourth cycle. More specifically, the set time is time shorter than the time required for the fourth cycle to elapse from when the receiver 341 receives the application data, and may be determined by the clock 342 using a random number or the like, or may be determined by shifting a predetermined phase within the fourth cycle, for example.

The set time timer clocks the set time set in the manner described above. Specifically, the set time timer starts clocking the set time when application data is received by the receiver 341, and clocks the set time within the fourth cycle.

The transmitter 343 transmits the application data received by the receiver 341 to the network 102, at each fourth cycle, and at timing determined depending on whether a resetting command has been received within the fourth cycle after application data is received by the receiver 341. Specifically, the transmitter 343 transmits an application frame of the application data received by the receiver 341 to the network 102 when the set time timer clocks the set time.

If the resetting command has been received by the receiver 341, the set time has been reset. Therefore, the transmitter 343 transmits the application frame to the network 102 at timing different from that at which a frame was transmitted previous time within the fourth cycle. If no resetting command is received by receiver 341, because the set time has not been reset, the transmitter 343 transmits the application frame to the network 102 at the same timing as that at which a frame was transmitted previous time within the fourth cycle.

In the third embodiment, the destination determiner 254 may determine one or more of the slave devices 210, the master device 220, and the transfer device 340, as a destination to which the resetting command is to be transmitted.

FIG. 18 is a flowchart illustrating an exemplary steps of a process performed in the communication device 330 according to the third embodiment.

The application 232 waits until the fourth cycle timer clocks (measures) the fourth cycle (No at Step S701).

If the fourth cycle timer clocks the fourth cycle (Yes at Step S701), the application 232 measures the amount of electric power, and generates application data by adding (stamping) a time stamp ty indicating the local time clocked by the clock 331 to the measured amount of electric power (Step S703).

The transmitter 333 then transmits an application frame of the application data generated by the application 232 to the transfer device 340 (Step S705). The process then returns to Step S701.

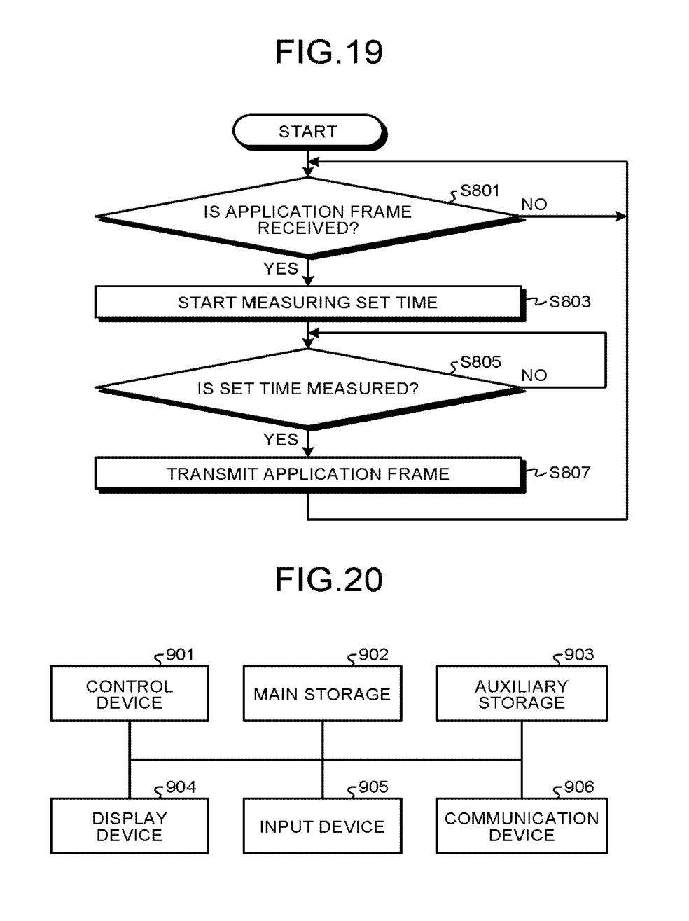

FIG. 19 is a flowchart illustrating an exemplary steps of a process performed in the transfer device 340 according to the third embodiment.

The receiver 341 then waits until an application frame is received from the communication device 330 (No at Step S801). When the application frame is received (Yes at Step S801), the set time timer starts clocking the set time (Step S803).

The transmitter 343 then waits until the set time timer clocks the set time (No at Step S805). When the set time timer clocks the set time (Yes at Step S805), the transmitter 343 transmits the application frame received by the receiver 341 to the network 102 (Step S807). The process then returns to Step S801.

To explain the steps of the resetting process performed in the transfer device 340 with reference to FIG. 14, the receiver 341 receives the resetting command from the management device 250, and the clock 342 resets the set time.

As described above, according to the third embodiment, even when the communication device is incapable of changing the timing at which an application frame is transmitted, the transfer device can change the timing at which the application frame is transmitted. Therefore, it requires shorter time for the communication delay to satisfy the predetermined precision.

Hardware Configuration

FIG. 20 is a schematic illustrating an exemplary hardware configuration of the slave device, the master device, the management device, the communication device, and the transfer device according to the embodiments (hereinafter, referred to as devices according to the embodiments). As illustrated in FIG. 20, the devices according to the embodiments include a control device 901 such as a CPU, a main storage 902 such as a ROM and a RAM, an auxiliary storage 903 such as an HDD or an SSD, a display device 904 such as a display, an input device 905 such as a keyboard and a mouse, and a communication device 906 such as a communication interface, and have a hardware configuration using a general computer.

The computer program executed on each of the devices according to the embodiments is provided in a manner stored in a computer-readable storage medium, which may be provided as a computer program product, such as a compact disc read-only memory (CD-ROM), a compact disc rewritable (CD-R), a memory card, a digital versatile disc (DVD), or a flexible disk (FD), as a file in an installable or executable format.

The computer program executed on each of the devices according to the embodiments may be stored in a computer connected to a network such as the Internet, and made available for download over the network. The computer program executed on each of the devices according to the embodiments may also be provided or distributed over a network such as the Internet. The computer program executed on each of the devices according to the embodiments may be provided incorporated in a ROM or the like in advance.

The computer program executed on each of the devices according to the embodiments has a modular structure implementing the units described above on a computer. As actual hardware, the units are implemented on the computer by causing the CPU to read the computer program from the ROM or the HDD onto the RAM, and to execute the computer program. When the units are implemented as hardware such as an IC at least partially, the devices according to each of the embodiment may be further provided with the IC.

The steps in the flowcharts explained in the embodiment may be executed in different orders, some of the steps may be executed simultaneously, or may be executed in different orders in each implementations, as long as the implementations are not against the nature of the steps.

As described above, according to the embodiments, cyclic of data communication can be ensured while avoiding confliction of communication in the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a communicating unit configured to communicate with another communication device over a network at each first cycle;
an estimator configured to calculate an outgoing communication delay and an incoming communication delay in communication between the communication device and the another communication device at each first cycle, and estimate a communication delay between the communication device and the another communication device based on the outgoing communication delay and the incoming communication delay;
a determiner configured to determine whether the communication delay satisfies a predetermined precision;
an application configured to generate application data at each second cycle; and
a transmitter configured to transmit the application data to the network at each second cycle, at timing determined based on a determination result of the determiner within the second cycle.

2. The device according to claim 1, wherein the transmitter is configured to, when the communication delay does not satisfy the predetermined precision, transmit the application data to the network at timing different from that at which data was transmitted previous time within the second cycle.

3. The device according to claim 1, wherein the transmitter is configured to, when the communication delay satisfies the predetermined precision, transmit the application data to the network at same timing as that at which data was transmitted previous time within the second cycle.

4. The device according to claim 1, wherein the estimator is configured to estimate the communication delay as a half of round-trip communication delay that is a sum of the outgoing communication delay and the incoming communication delay.

5. The device according to claim 1, wherein
the another communication device is a master device that is a time source for synchronization,
the communicating unit is configured to communicate synchronization data for time synchronization with the another communication device,
the synchronization data transmitted from the another communication device includes a first time stamp indicating reference time clocked by the another communication device, and
the communication device further comprises a synchronizer configured to synchronize time based on the communication delay and the first time stamp.

6. The device according to claim 5, further comprising a clock configured to clock local time, wherein
the synchronizer is configured to calculate an offset between the reference time and the local time using the communication delay, the first time stamp, and the local time at which the synchronization data is received, and cause the clock to correct the local time clocked by the clock using the calculated offset.

7. The device according to claim 1, wherein
the application is configured to measure an amount of electric power, and
the application data includes the measured electric power and a second time stamp indicating the local time at which the application data is generated.

8. A communication system comprising:
a first communication device; and
a second communication device, wherein
the first communication device includes
a first communicating unit configured to communicate with the second communication device over a network at each first cycle,
an estimator configured to calculate an outgoing communication delay and an incoming communication delay in communication between the first communication device and the second communication device at each first cycle, and estimate a communication delay between the first communication device and the second communication device based on the outgoing communication delay and the incoming communication delay,
a determiner configured to determine whether the communication delay satisfies a predetermined precision;
an application configured to generate application data at each second cycle, and
a transmitter configured to transmit the application data to the network at each second cycle, at timing determined based on a determination result of the determiner within the second cycle, and
the second communication device includes a second communicating unit configured to communicate with the first communication device over the network at each first cycle.

9. A communication system comprising:
a plurality of first communication devices;
a second communication device; and
a management device, wherein
each of the first communication devices includes
a first communicating unit configured to communicate with the second communication device over a network at each first cycle,
an estimator configured to calculate an outgoing communication delay and an incoming communication delay in communication between the first communication device and the second communication device at each first cycle, and estimate a communication delay between the first communication device and the second communication device based on the outgoing communication delay and the incoming communication delay,
a second communicating unit configured to transmit the communication delay to the management device, and receive a resetting command from the management device,
a first application configured to generate first application data at each second cycle, and
a first transmitter configured to transmit the first application data to the network at each second cycle, at timing determined depending on whether the resetting command has been received within the second cycle,
the second communication device includes a third communicating unit configured to communicate with the first communication device over the network at each first cycle, and
the management device includes
a first receiver configured to receive the communication delays from the respective first communication devices;
a first determiner configured to determine whether the communication delays satisfy a predetermined precision;
a second determiner configured to, when the communication delays do not satisfy the predetermined precision, determine one or more devices of the first communication devices as a destination to which the resetting command is to be transmitted, and
a second transmitter configured to transmit the resetting command to the one or more devices.

10. The system according to claim 9, wherein
the second communication device further includes
a second receiver configured to receive the resetting command from the management device,
a second application configured to generate second application data at each third cycle, and
a third transmitter configured to transmit the second application data to the network at each third cycle, at timing determined depending on whether the resetting command has been received within the third cycle, and
the second determiner is configured to determine the one or more devices from the first communication devices and the second communication device.

11. The system according to claim 9, further comprising a third communication device, wherein
the third communication device includes
a third receiver configured to receive the resetting command from the management device;
a third application configured to generate third application data at each fourth cycle, and
a fourth transmitter configured to transmit the third application data to the network at each fourth cycle, at timing determined depending on whether the resetting command has been received within the fourth cycle, and
the second determiner is configured to determine the one or more devices from the first communication devices, the second communication device, and the third communication device.

12. The system according to claim 9, further comprising:
a third communication device; and
a transfer device, wherein
the third communication device includes
a third application configured to generate third application data at each fourth cycle; and
a fourth transmitter configured to transmit the third application data to the transfer device,
the transfer device includes
a fourth receiver configured to receive the third application data from the third communication device, and receive the resetting command from the management device, and
a fifth transmitter configured to transmit the third application data to the network at each fourth cycle, at timing determined depending on whether the resetting command has been received within the fourth cycle after the third application data is received, and
the second determiner is configured to determine the one or more devices from the first communication devices, the second communication device, and the transfer device.

13. An estimation method executed on a communication device, the method comprising:
communicating between the communication device and another communication device over a network at each first cycle;
calculating an outgoing communication delay and an incoming communication delay in communication between the communication device and the another communication device at each first cycle;
estimating a communication delay between the communication device and the another communication device based on the outgoing communication delay and the incoming communication delay;
determining whether the communication delay satisfies a predetermined precision;
generating application data at each second cycle; and
transmitting the application data to the network at each second cycle, at timing depending on a determination result at the determining within the second cycle.

14. A computer program product comprising a computer-readable medium containing a program executed by a computer serving as a communication device, the program causing the computer to execute:
communicating between the communication device and another communication device over a network at each first cycle;
calculating an outgoing communication delay and an incoming communication delay in communication between the communication device and the another communication device at each first cycle;
estimating a communication delay between the communication device and the another communication device based on the outgoing communication delay and the incoming communication delay;
determining whether the communication delay satisfies a predetermined precision;
generating application data at each second cycle; and
transmitting the application data to the network at each second cycle, at timing depending on a determination result at the determining within the second cycle.
